(19) United States
(12) Patent Application Publication
(10) Pub. No.: US 2020/0068799 A1
(43) Pub. Date: Mar. 5, 2020

(54) AN ENERGETICALLY AUTONOMOUS, SUSTAINABLE AND INTELLIGENT ROBOT

(71) Applicant: The Toadi Order BV, Waregem (BE)

(72) Inventors: Mike SLEMBROUCK, Zwevezele (BE); Lorrez WESLEY, Waregem (BE)

(73) Assignee: The Toadi Order BV, Waregem (BE)

(21) Appl. No.: 16/499,340

(22) PCT Filed: May 22, 2018
(86) PCT No.: PCT/EP2018/000268

§ 371 Date: Sep. 30, 2019

(30) Foreign Application Priority Data
May 23, 2017 (BE) BE2017/0067

(51) Int. Cl. A01D 34/00; G05D 1/02; A01D 34/54

(52) U.S. Cl. CPC A01D 34/008; G05D 1/0274; G05D 1/0221; A01D 34/43; A01D 34/54; G05D 2201/0208; G05D 1/0251

(57) ABSTRACT

An Energetically Autonomous, Sustainable and Intelligent Robot (ESAIR) moving within a given working area. From an energetic point of view, the Robot is autonomous and determines itself how and when given tasks are performed.

The present invention relates to an Energetically Autonomous Sustainable Intelligent Robot (EASIR), which may configured to execute one or more of different tasks, i.e. gardening, cleaning, vacuum cleaning, etc

### BACKGROUND

Robots are being developed for executing a lot of different tasks in a household but also in other areas of society and industry. Most robots need to be freely movable which causes a problem of the energetic autonomy of the robot, in particular when the consumption of energy is relatively high. A solution could be to connect the robot to an electrical supply by an electric cable. This solution limits the possible use of the robot. Another solution may be sought in a greater battery, part of the robot, but this will increase the weight of the robot with, as a consequence, an even higher need of energy. A solution found for gardening purposes is providing a docking station enabling a regular charging of the battery of the robot. Such a lawn mower robot is described in US 2013/212994. However, this robot has the drawback that a power supply is still needed for feeding the docking station. Another drawback consists in the limited time duration the robot may be continuously used, which duration is limited by the capacity of battery of the robot.

These drawbacks are overcome by providing a robot according to the present invention.

### SUMMARY

The object of the present invention is to provide an Energetically Autonomous Sustainable Intelligent Robot (ESAIR) adapted to move within a working area and comprising an energy generating source, a computer vision system, a localization system, a drive system for moving the robot, a tool for executing a given task within the working area, a processing unit for processing the data signal from the computer vision system and/or from the localization system, the processing unit being configured to feed an Artificial Intelligent system so as to obtain a detailed 3D map of the working area or of a part of the working area and to obtain command signals for the driving system and the tool, artificial intelligent software to understand the environment and to make decisions on its own knowledge, a memory storing the map of the working area or of part of the working area. The robot may further comprise an energy storing means and means to determine the best geographic points or areas within the working area on which points or areas the energy generating source can receive external energy for charging the energy storing means and to determine the best time slot within which there may be reception of external energy. Said points or areas may be stored on said map of the working area.

The working area may comprise plural disconnected working areas or working areas which are partly disconnected.

The robot may further comprise a gyroscope and/or a compass.

The robot may further comprise an electronic communicating device which may include a display.

The tool may be a lawn mower comprising a blade reel system.

The robot may comprise a four wheel powered driving system and/or a driving system based on a caterpillar system.

The robot may comprise an automatic height system for the mower.

The robot may also comprise the hardware and programs to function as a guard.

It is another object of the present invention to provide a method for mowing a lawn using the robot previously described and comprising the steps of capturing an image of the lawn to be mowed by means of a computer vision system, analyzing the captured data to understand the surroundings and mapping the lawn area and/or obstacles and/or, to house or building and/or the lawn perimeter, using the analyzed captured data to drive the robot and instructing the robot to mow the grass.

The method may further comprise the step of measuring the height of the grass whereby instructing the robot to mow the grass may comprise instructing to mow at appropriate height.

It is still another object of the present invention to provide a computer program comprising program code means for performing all the steps of the methods, described above when said program is run on a computer.

It is still another object of the present invention to provide a computer program product comprising program code means stored on a computer readable medium for performing the methods described above when said program product is run on a computer.

### BRIEF DESCRIPTION OF THE DRAWINGS

FIG. 1A gives two general views of a robot according to the invention: one figure shows a side view of a lawn mower robot, the second figure gives a perspective view of such a lawn mower robot.

FIG. 1B shows a block diagram of a robot according to the invention.

FIG. 2: illustrates a method of using a robot when mowing a lawn.

FIG. 3: illustrates different ways of using the information on the charging capacity (or the power availability) at different locations (charge locations) within the working area.

FIG. 4: illustrates a blade reel system of a lawn mower.

FIG. 5: illustrates a block diagram of a method of mowing the grass according to a given pattern.

FIG. 6: gives a perspective view of a lawn mowing robot having a driving system based on a caterpillar system.

FIG. 7: shows a block diagram of a method of maintaining a grass lawn.

FIG. 8: gives a block diagram of a method for adding a new working area to the operational tasks of a lawn mower robot.

FIG. 9A: illustrates a side view of a lawn mowing robot with a folded solar panel.

FIG. 9B: illustrates a side view of a lawn mowing robot with an unfolded solar panel.

### DETAILED DESCRIPTION OF THE EMBODIMENTS

Definitions: the following terms used in the description and the claims have the following meaning:

By “energetically autonomous robot” is meant a robot which generates its own electrically energy by capturing energy available in the physical world such as light or radiant energy, wind energy and transforming this captured energy directly into electrical energy, which can be used by the robot e.g. by using energy from solar cells or windmills installed on the robot; such a robot does not need a docking or charging station in which the robot is connected to a source of electrical energy.

By “energy generating means” is meant any means capturing energy external to the robot and converting it directly to energy which can be used by the robot e.g. means using solar cells, windmills, etc.

By “a computer vision system” or “a machine vision system” is meant a 3D vision system or a stereo-vision camera, an IR depth camera, a 3D camera, an RGB sensor, a sound based detector, a heat camera or a combination of such cameras whereby the cameras are connected to a computing element or processing unit configured to analyze the images of the cameras in order to get information like distance to a certain object, height of a certain object; characteristics of imaged objects, etc.

By “understand the environment or the map” is meant after having analyzed the captured map, and by using e.g. image recognition techniques determine the kind of surface in the surroundings (near or further away) of the robot e.g. the surface is a lawn, or the surface is a path, or the surface belongs to a building or a tree, and determining characteristics of specific items in the surroundings of the robot e.g. the height of the grass, etc.

By “a localization system” is meant e.g. a localization system based on a number of fixed points detected and represented by a computer vision system or a localization system based on GPS or a system based on local “beacons” or a system based on inertial instruments such as a gyroscope and/or a compass, a system based on visual markers recognized and tracked via the vision system or a combination of such systems or any other suitable localization system.

The localization system may be integrated in the processing unit and its associated software.

By “Operational Tasks”: the tasks to be executed by the robot.

By “Time of operation”: the time needed to finish a given operational task.

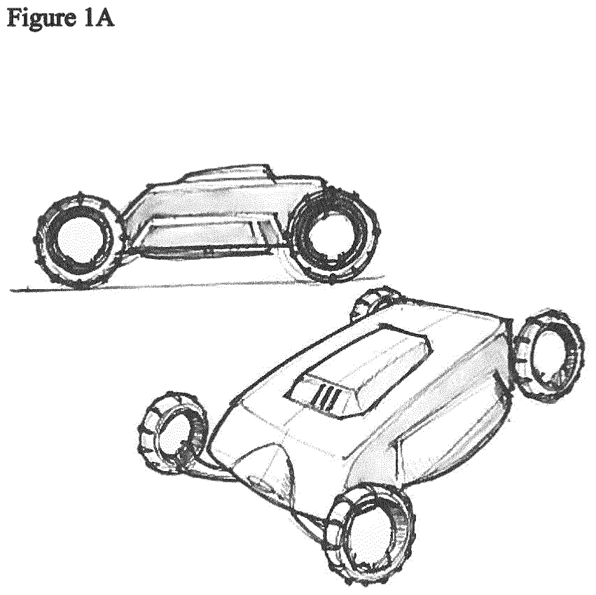

According to one aspect of the invention, an energetically autonomous sustainable intelligent robot (further called robot) includes a robot body (FIG. 1B, 104), a drive system (105) supporting the robot body and configured to move the robot over a working area, an energy generating source (101), a tool (106) to execute a given task,. a computer vision system (102) and a processing unit with the necessary software (103) for processing the data signals from the computer vision system and optionally from the localization system, in order to map and understand the surroundings of the robot and in order to obtain command signals for the driving system and the tool, a software system (103) to control the robot, The robot further includes a decision unit and uses artificial intelligence techniques. The decision unit determines an operational task to be executed based on a certain number of criteria. e.g. in the case of a lawn mower robot, the robot may decide to mow the lawn on the basis of the time elapsed since the last mowing took place and/or on the basis of the height of the grass and/or of the growing speed of the grass and/or of the degree of wetness of the grass and/or of the weather forecast and/or of the time necessary to mow the grass and/or of the availability of the energy needed, etc. The decision unit may be incorporated in the processing unit.

The robot may be provided with an energy storing means, but this is not absolutely necessary.

The mechanical and electronic design of the robot can be carefully and precisely worked out to have a highly light weighted body frame, a drive system and an electronic system to achieve a highly energy efficient system. The specific lightweight and rigid ability of this invention are keys to success.

As an example: in the case of a robot lawn mower, the weight of the robot should preferably be lower than 2.1 kg to be highly energy efficient. Today's smallest robot mower weights over 7 kg and is not equipped with an energy system to recharge itself and thus needs to have a docking station for charging Optionally, the robot mower can have a battery to store energy allowing the robot to function while not having sun, or to work in areas that are covered by a shadow.

Further, when the robot is a lawn mower, the computer vision based system in combination with the artificial intelligent system can detect lawn, obstacles, puts, hills, pond, people, house . . . It may also detect the boundaries of mow zones. It could also be used to create a 3D depth map of the area, including the height of the grass, the location of a house and trees.

In some embodiments the Energetically Autonomous Sustainable Intelligent Robot also includes a gyroscope and/or compass to extract more data for the artificial intelligent system and enables the robot to precisely know its level orientation and create a level based information map about the area. In case of a mower robot, this information allows the artificial intelligent system to decide to mow the lawn in a smarter way, keeping the different levels in consideration.

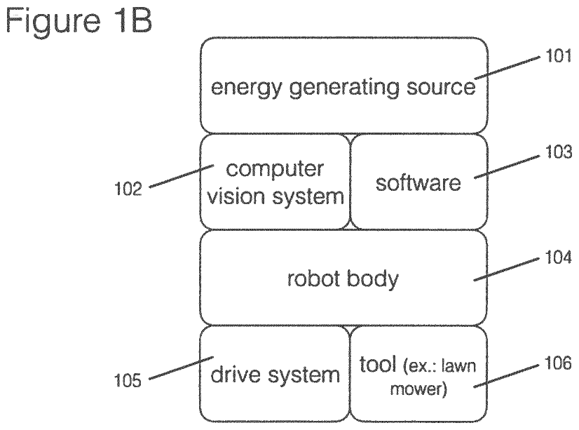

FIG. 2 illustrates a method of using a robot when mowing a lawn. In a first step (201), the robot determines its own location and the destination (end of the mowing task) on the stored map, obtained by the computer vision system. In the next step (202) a route between the known location and the destination point, is determined and verified, i.e. is this route passing over the lawn to be mowed, are there no obstacles on the road which cannot be overcome by the robot, etc. In a following step (203) the robot is started and moved along the determined route between the own location and the destination point. In step 204 the robot is continuously moved towards the destination and finally in step 205, the moving of the robot is stopped when the destination point is reached.

Step 204 may include other steps, e.g. a step (206) during which the type of ground in front of the robot is recognized (e.g. is the area in front of the robot covered with grass or not); and/or a step (207) during which obstacles in front of the robot are recognized: and finally a step (208) during which the robot is mowing the grass when grass is detected in front of the robot and when no obstacles are detected.

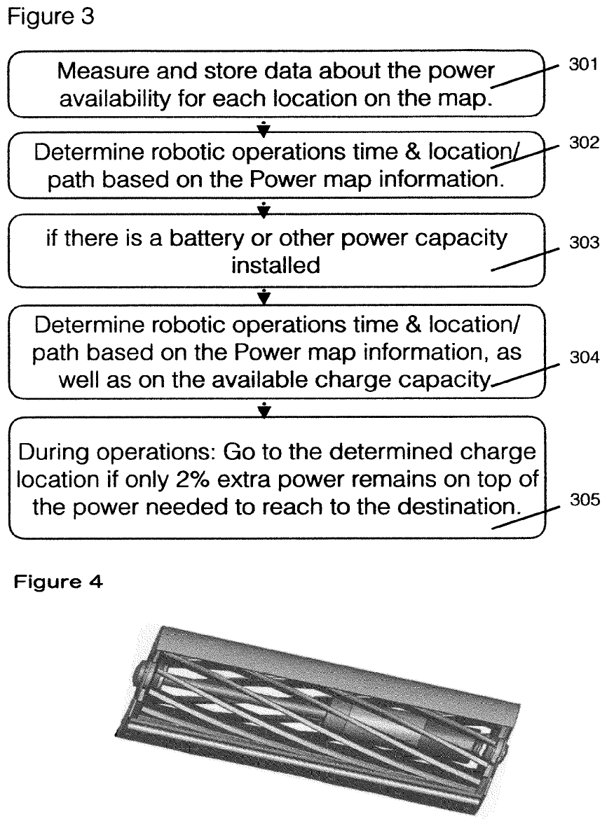

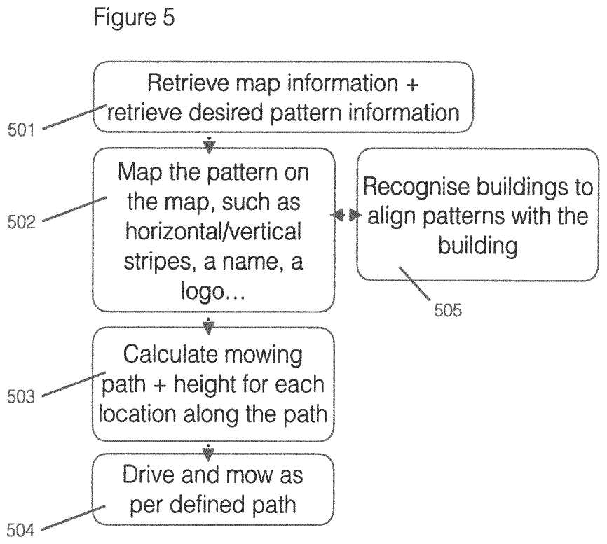

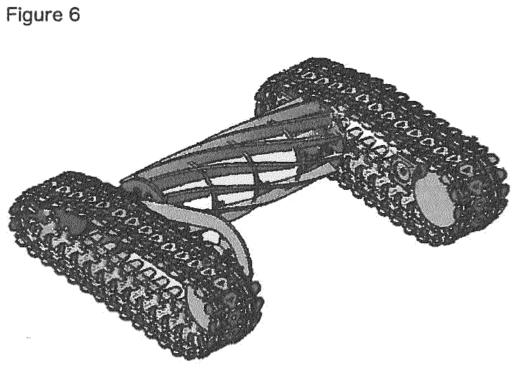

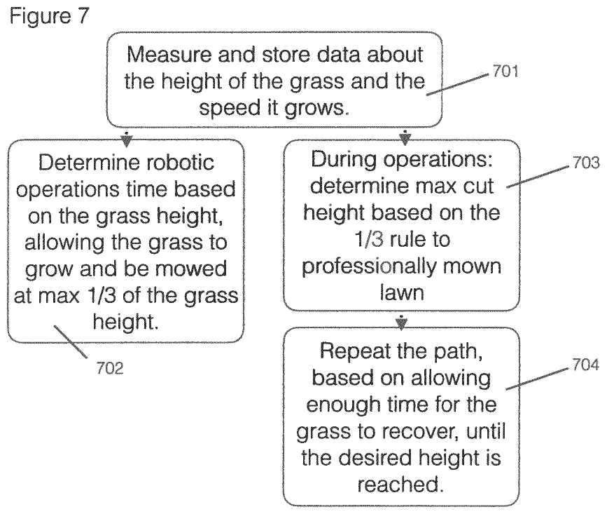

In some further embodiments the energetically autonomous, sustainable and intelligent robot mower also includes a blade reel system (FIG. 4) to deliver the highest grass cutting quality. Today, commercial house robot mowers all use a rotary blade system because known blade reel systems have a weight which is too high. In this invention we present for the first time a robot lawn mower using a newly designed blade reel system, to cut the grass at the highest quality. A rotary blade mower harms the grass while cutting it because it uses brute force to cut it. A blade reel mower on the contrary, works like a scissor and gently cuts the grass. Professional mowers for football fields and golf yards are generally blade reel type of mowers because of the high quality of cutting.

In order to take into account the limitation in weight of the robot, the blades of newly designed blade reel system are made of hard plastic. Each rotating blade, constitutes one leg of the scissor, mentioned above, the other leg being constituted by the metallic strip mounted on the fixed part of the blade reel mower.

Very general again, the energy generating system could for example be solar panels, wind turbines or any other means to generate power on the robot itself with the exception of energy storing means. The robot may be provided with one or more wings on which solar cells are installed. These wings may be unfurled e.g. for increasing the energy produced by the solar cells.

In some further embodiments the energetically autonomous sustainable intelligent robot mower also includes an automatic height system for the mower enabling the robot to self-control the height to cut the grass. Today's robot mowers cut the grass all the time, only cutting a small part of the height of the grass. Their cutting height can be manually set at a fix height by the customer. By introducing an electronic automated height system the robot mower can set the height of the grass itself, making it possible to maintain the grass with more intelligence. For example, it is a golden rule in grass maintenance that you cannot mow the grass with more than ⅓ of the grass, as well as you cannot mow the grass continuously. Today's mowing robots cannot deliver this high quality level of grass maintenance, while the system presented in this invention can. It can detect the height of the grass and set the height to cut the grass as well. In this way it enables a higher grass maintenance level then todays grass mowing robots.

A method of maintaining a grass lawn according to the present invention is shown in block diagram 7.

In step 701, the height of the grass is measured and also the speed it grows; the data relating to these measurements may be stored.

In step 702 the time of the operation of the robot may be determined on the basis of the grass height, allowing the grass to grow and to be mowed at maximum ⅓ of the grass height.

In step 703: the maximum cut height is determined during the operation of the robot; this maximum cut height is determined on the basis of the ⅓ rule.

In step 704: the operation of 703 is repeated until the desired or appropriate height of the grass is reached after the necessary recovery time of the grass

It also makes it possible to instruct the robot to mow lines (stripes) in the grass, or design messages and logos (e.g.: a heart on Valentine, or a name or . . . ) in the grass. A method of cutting a grass lawn according to the present invention and following a certain pattern is shown in block diagram 5. According the method shown, in step 501 map information of the work area is retrieved and also the information concerning the desired pattern of mowing. In step 502, the desired pattern are mapped on the map of the work area while in step 503 the mowing path, realizing the desired pattern, is calculated and also the height of each location along this mowing path. Finally in step 504, the mowing robot is driven along the calculated mowing path. In an intermediate step 505, existing buildings are recognized in order to align patterns with one of these buildings when desired.

In some embodiments the energetically autonomous sustainable intelligent robot mower also includes an electronic communication device. This device makes it possible to send alerts, pictures, video, obstacle information to the user, as well as it makes it possible to download weather forecast information. The weather forecast can be used as data for the artificial intelligent system, charging activities. As well as the wireless communication method makes it possible for users to remotely control the device.

Furthermore, in case of a robot mower, the electronic communication device can also be used to send mower information to the user or pictures relating to the lawn and the weather forecast information may enable the robot mower to plan its mowing activities. In some embodiments the energetically autonomous sustainable intelligent robot can also be programmed to function as a guard. The robot could drive around in the garden at several intervals and detect intruders or traces of intrusion. As well as the robot could inspect windows and doors for traces of intrusion. Or the robot could take position at the back-yard door and guard it permanently. As well as the robot could be programmed to guard the pool against drowning of kids or adults. As well as the robot could be programmed to execute many other vision commanded function in the garden, for example, drifting away moles. In a preferred embodiment of the robot mower, one or more of these “guard” functions may also be provided. Another aspect of the invention features a method of configuring an energetically autonomous sustainable intelligent gardening robot. The method includes capturing image and depth data by means of a camera, a stereo-vision camera, a IR depth camera, a 3D camera, a heat camera or any other image capturing device. Included may also be the analyzing the captured data to understand the surrounding and map the lawn area, obstacles, the house, the lawn perimeter, while real-time understand where obstacles are, recognize people and animals. The method further uses the analyzed data to drive the robot and take appropriate actions as per analyzed situation and available data, instructions.

The same method measures the height of the grass and instructs the robot to mow at appropriate height As well as this method makes sure the mower doesn't bounce to trees, people or other obstacles, and it doesn't drive into puts or pounds, while making sure it understands hills. The method measures the level of height-increase before it decides to mount the hill or how to mount it.

Another aspect of the invention features a method of configuring a smart energetically Autonomous Sustainable charging system which may be part of the energetically Autonomous Sustainable Intelligent Robot. The method uses the computer vision based system and/or the artificial intelligence system to track and learn the best charging spots, for example, the best locations in the garden to charge the robot by means of a solar panel mounted on the robot. Based on location, time and weather, the robot inspects and measures how much sun falls on a given location of the map. Obstacles causing shadows are taken into account when measuring. Based on the available spots, and the real-time weather, the robot calculates and estimates the best charging times and locations.

The system itself comprises a solar panel, a battery and electronics to handle the charging.

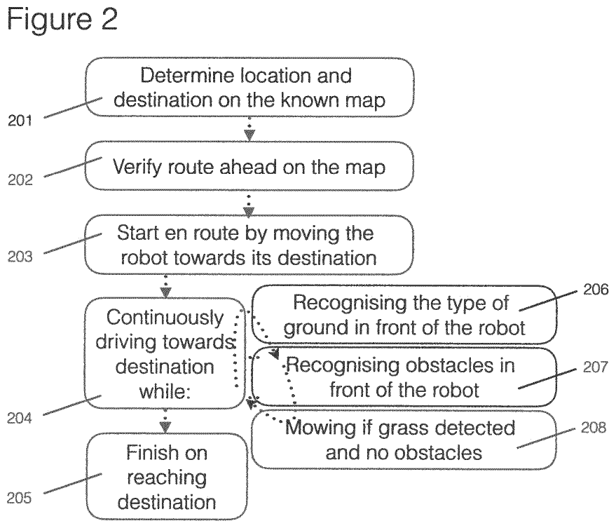

FIG. 3 illustrates different ways of using the information on the charging capacity (or the power availability) at different locations (charge locations) within the working area. First the power availability on different locations within the working area is measured and the measured data for each location are stored on the map (power map) of the working area (301). The time of the day the power is available may also be stored. Based on the information, contained in the power map, the time needed by the robot to execute a given task, is determined and also is the location and path of the robot during the execution of this task (302). if the robot has it its own battery or other power capacity (303), the time and location and path mentioned above are determined taking also into account the available charging capacity of said own battery or other power capacity (304). During the operations itself (i.e. during the robot executing the given task), the robot goes to a determined charge location if the power available in the battery falls below a given level (e.g. 102% of the power needed by the robot to reach destination) (305).

Another aspect of the invention features a method of mowing in stripes or other patterns. The method uses the computer vision based system and/or an artificial intelligence system to mow the lawn in lines (stripes). It is commonly known that professionals mow their grass in stripes. Today's robot mowers mow grass in random patterns. While this invention makes it possible to mow the lawn in stripes or other patterns. The method could also detect a house or building on the lawn, and mow the lawn in stripes aligned with the house, enabling a professional looking mowed lawn. Or, the user could send commands (in form of shapes, images, instructions) to the robot mower to cut patterns, signs, text, logo's or other creative shapes in the lawn. For example, a user could instruct the robot mower to make the shape of a heart in the lawn and mention the name of his wife, as well as instruct the mower to do this early in the morning on Valentine day.

In some embodiments the energetically Autonomous Sustainable Intelligent Robot mower creates a detailed 3D map of the lawn, ponds, trees, walls, bushes, flowers and its complete surrounding, including the building(s) on the property, enabling the robot full awareness of its surrounding.

In some embodiments the energetically Autonomous Sustainable Intelligent Robot mower works together with one or multiple energetically Autonomous Sustainable Intelligent Robot mowers to mow large terrains. They communicate with each other to determine each individual area to cover, as well as they share information such as for example information about charging locations, 3D maps, obstacle maps.

Another aspect of the invention features a method of mowing multiple lawns. The method makes it possible to detect lawns that are not connected to the lawn the robot is on. For example, there may be a small lane between the lawn the robot is on and another lawn or the grass may divided by a walkway. The robot can detect this via its computer vision and artificial intelligence system. Upon detection the robot informs the user and waits for further instructions. The user can command the robot to mow that another lawn as well or to deny that lawn. In case the user commands the robot to mow that lawn as well, the robot will automatically mow both (or more) lawns from then on until new instructions are given.

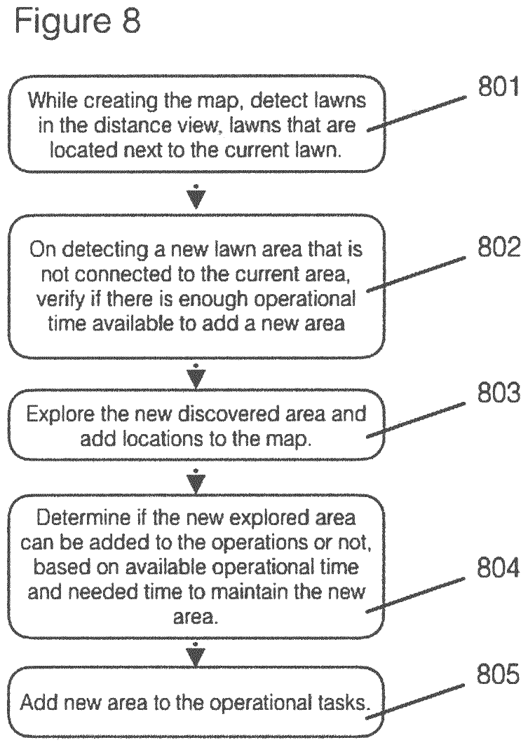

FIG. 8 gives a block diagram of a method for adding a new working area to the operational tasks of a lawn mower robot of the present invention.

In a first step (801) the robot detects in the distance view (a view which contains an indication of distances between the robot itself and other items seen by the computer vision system) lawns which are located next to the current lawn which is a lawn or working area already detected and processed by the robot. In a following step (802), on detecting such a new lawn that is not connected to the current area, the robot verifies whether there is enough operational time (the time the robot can perform its task and which is based on the capacity of the installed battery). In a next step (803), the new lawn/area is explored by the robot in order to add the locations to the map (see step 301 in FIG. 3).

In step 804, the robot determines whether the new explored lawn/area can be added to the operations (=a list of tasks stored by the robot) or not based on available operation time (=time based on the energy consumption of the robot when performing its task, on the capacity of the battery and on the amount of energy which can be received and stored on the “locations”). and the time needed to maintain the new lawn/area. In step 805 the new area/lawn is added to the operational tasks if the result of step 804 is positive.

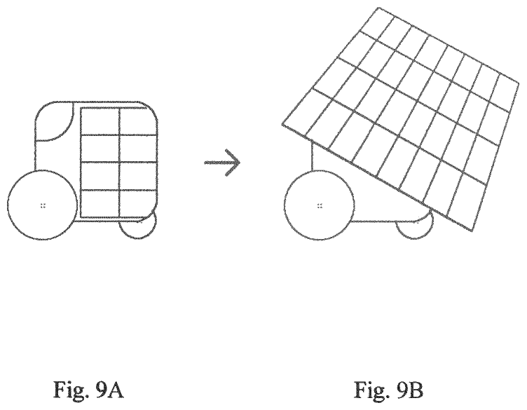

FIG. 9A shows, as an example, a side view of a robot mower according to the invention. The robot mower is equipped with a solar panel which is folded.

FIG. 9B shows, as an example, another side view of this robot mower according to the invention. The robot mower is equipped with a solar panel but which is now unfolded. Preferably, the solar panel is mounted in a way that it is orientable, e.g. in the direction of the sun.

In some embodiments the energetically Autonomous Sustainable Intelligent Robot mower can include a communication device such as a display or LED's. The display or LED's can be used to display information such as for example the battery level, mowing information or information on errors.

In some embodiments the driving system of the energetically Autonomous Sustainable Intelligent Robot mower can be a four (4) wheel powered driving system. Compared to today's robot mowers, a 4 wheel powered driving system will enable a more stable system and higher traction to mount hills for example.

In some embodiments the driving system of the energetically autonomous sustainable intelligent robot could be a flying mechanism as for example those of a drone or a mechanism for the water, as a boat.

In some embodiments the driving system of the energetically Autonomous Sustainable Intelligent robot mower can have a method of eliminating and clearing out sticking grass clippings and/or other dirt that could clog the device. As it clogs and sticks to any commercial grass mower available today. The method consists of applying a super hydrophobic coating on the interior of the device as well as on the reel system parts. Any dirt or grass clippings touching this coating are repelled and simply roll off and by this, the extra coating makes sure dirt or grass clippings doesn't stick on/to the inner parts of the robot mower.

In some embodiments the driving system of the energetically Autonomous Sustainable Intelligent Robot mower can be a caterpillar based system (FIG. 8). Compared to today's robot mowers, a caterpillar type driving system will enable a more stable system and higher traction to mount hills for example.

The invention is not limited to the examples and embodiments described above. The different features belonging to any of these examples or embodiments may also be introduced in other embodiments. The present invention comprises also embodiments comprising different combinations of the features above. In particular, features described in relation with an energetically autonomous sustainable intelligent robot mower may also be used in other robots having another task than mowing. Such energetically autonomous sustainable intelligent robots are also part of the invention.

Other variations to the disclosed embodiments can be under-stood and effected by those skilled in the art in practicing the claimed invention, from a study of the drawings, the disclosure, and the appended claims. In the claims the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1-13. (canceled)

14. An intelligent robot adapted to move within a working area, comprising:
an energy generating source;
a computer vision system;
a localization system;
a drive system for moving the robot;
wherein the intelligent robot is energetically autonomous and sustainable, and the robot further comprises:
a tool for executing a given task within a working area;
a processing unit for processing a data signal from the computer vision system and/or from the localization system, the processing unit being configured to feed an artificial intelligent system so as to obtain a detailed 3D map of the working area or of a part of the working area and to obtain command signals for the driving system and the tool;
artificial intelligent software to understand the environment and to make decisions on its own knowledge;
a memory storing the map of the working area or of part of the working area;
whereby the boundaries of the working area are obtained by the processing of the data signal from the computer vision system.

15. The robot as described in claim 14, whereby the robot further comprises
an energy storing means; and
means to determine the best geographic points or areas within the working area on which points or areas the energy generating source can receive external energy for charging the energy storing means and to determine the best time slot within which there may be reception of external energy;
wherein said points or areas are stored on said map of the working area.

16. The robot as described in claim 14, wherein the working area comprises, plural disconnected working areas or working areas which are partly disconnected.

17. The robot as described in claim 14, further comprising a gyroscope and/or a compass.

18. The robot as described in claim 14, further comprising an electronic communicating device which may include a display.

19. The robot as described in claim 14, wherein the tool is a lawn mower comprising a blade reel system.

20. The robot as described in claim 14, wherein the tool is a lawn mower comprising a blade reel system and comprising a four wheel powered driving system and/or a driving system based on a caterpillar system.

21. The robot as described in claim 14, wherein the tool is a lawn mower comprising a blade reel system and comprising an automatic height system for the mower.

22. The robot as described in claim 14, comprising the hardware and programs to function as a guard.

23. A method for mowing a lawn using an energetically autonomous and sustainable robot, the method comprising the steps of:
capturing an image of the lawn to be mowed by means of a computer vision system,
analyzing the captured data to understand the surroundings and mapping the lawn area and/or obstacles and/or a house or building and/or the lawn perimeter;
using the analyzed captured data to drive the robot; and
instructing the robot to mow the grass.

24. The method for mowing a lawn of claim 23, further comprising the step of:
measuring the height of the grass, and
wherein the step of instructing the robot to mow the grass comprises instructing to mow at appropriate height.

25. A computer program comprising program code for performing the method of claim 23.

26. A computer program product comprising program code means stored on a computer readable medium for performing the method of claim 23 when said program product is run on a computer.
